(19) United States
(12) Patent Application Publication
(10) Pub. No.: US 2023/0299677 A1
(43) Pub. Date: Sep. 21, 2023

(54) POWER CONVERSION CIRCUIT WITH CURRENT LIMITED CLAMP

(71) Applicant: Texas Instruments Incorporated, Dallas, TX (US)

(72) Inventors: Hongcheng Xu, Freising (DE); Michael Schlenker, Marzling (DE); Konrad Wagensohner, Mauern (DE)

(21) Appl. No.: 18/184,111

(22) Filed: Mar. 15, 2023

Related U.S. Application Data
(60) Provisional application No. 63/320,170, filed on Mar. 15, 2022.

(51) Int. Cl. H02M 3/158; H02M 1/00

(52) U.S. Cl. CPC H02M 3/1582; H02M 1/0009; H02M 1/0032

(57) ABSTRACT

A power conversion circuit includes a transconductance amplifier circuit, a current limiting circuit, and a controller. The transconductance amplifier circuit is configured to provide a first output current at a first output based on a differential between a first voltage at the first input and a second voltage at a second input. The current limiting circuit is configured to provide a second output current at the second output that is an input current at a third input limited to no greater than the first output current. The controller is configured to control first and second switches during a time period where the power conversion circuit transitions between an active mode and a skip mode.

### CROSS-REFERENCE TO RELATED APPLICATION

This application claims the benefit of, and priority to, U.S. Provisional Patent Application No. 63/320,170, filed Mar. 15, 2022, which is incorporated herein by reference in its entirety.

### TECHNICAL FIELD

This description relates to power converters, and more particularly, to a power conversion circuit with a current limited skip clamp.

### BACKGROUND

Direct current (DC)-to-DC power converters, such as buck converters, buck-boost converters, and so forth, are used to regulate the voltage output to a load. For instance, a controller can monitor an output voltage of the DC-DC converter and vary the voltage of a control signal for stabilizing the output voltage. The controller may further account for a sudden change or fluctuation in the load, also referred to as a load transient response, by clamping or otherwise limiting the gain of the DC-DC converter in an attempt to stabilize the output voltage. There remain a number of non-trivial issues with respect to limiting the gain of converters.

### SUMMARY

One example includes a power conversion circuit having a transconductance amplifier circuit, a current limiting circuit, and a controller. The transconductance amplifier circuit has a first input coupled to a first integrator circuit terminal, a second input coupled to a second integrator circuit terminal, and a first output. The transconductance amplifier circuit is configured to provide a first output current at the first output based on a differential between a first voltage at the first input and a second voltage at the second input. The current limiting circuit has a third input coupled to a current source terminal, a fourth input coupled to the first output via a first switch, and a second output coupled to a reference current circuit terminal via a second switch. The current limiting circuit is configured to provide a second output current at the second output that is an input current at the third input limited to no greater than the first output current. The controller is configured to control the first and second switches during a time period where the power conversion circuit transitions between an active mode and a skip mode.

Another example includes a power conversion circuit having a transconductance amplifier circuit, a current limiting circuit, and a controller. The transconductance amplifier circuit is configured to provide a first output current based on a differential between a first voltage and a second voltage. The current limiting circuit is configured to provide a second output current that is an input current limited to no greater than the first output current. The controller is configured to control a switch coupled to an output of the current limiting circuit.

Another example includes at least a portion of a skip clamp circuit having first, second, third, and fourth transistors. The first transistor is coupled between a first voltage terminal and a second voltage terminal, and has a first control terminal coupled to a first input. The second transistor is coupled between the first transistor and the second voltage terminal, and has a second control terminal coupled to a second input. The third transistor is coupled in parallel with the first transistor, and has a third control terminal. The fourth transistor is coupled between the first voltage terminal and an output, and has a fourth control terminal coupled to the third control terminal.

### BRIEF DESCRIPTION OF THE DRAWINGS

FIG. 1 is a block diagram of a power converter, in an example.

FIG. 2 is a circuit diagram of the power converter of FIG. 1, in an example.

FIG. 3 is a circuit diagram of a portion of the circuit shown in FIG. 2, in an example.

FIG. 4 illustrates simulated signal timing of the power converter of FIG. 1 during power save mode operation, in an example.

FIG. 5 is a state table of a controller of the power converter of FIG. 1, in an example.

FIG. 6 is a schematic diagram of a portion of the power converter of FIG. 1, in an example.

FIG. 7 illustrates simulated results of power save mode operations of the power converter of FIG. 1, in an example.

FIG. 8 is a schematic diagram of an integrator and a transconductance amplifier circuit of the power converter of FIG. 1, in an example.

FIG. 9 is a graph depicting simulated performance of an example of a power converter without a skip clamp.

FIG. 10 is a graph depicting simulated performance of the power converter of FIG. 1, in an example.

### DETAILED DESCRIPTION

Power conversion techniques for DC-DC converters are described herein. The techniques can be used in any number of configurations but are particularly well-suited for a converter configuration having a low-power or power save mode. The power save mode is useful for increasing the efficiency and reducing the power consumption of the converter while a load coupled to the converter is in an idle or standby (e.g., ultra-low power) state of operation. In an example, a power conversion circuit includes a skip clamp circuit, which further includes a transconductance amplifier circuit, a current limiting circuit, and a controller. The transconductance amplifier circuit has a first input coupled to a first integrator circuit terminal, a second input coupled to a second integrator circuit terminal, and a first output. The current limiting circuit has a third input coupled to a current source terminal, a fourth input coupled to the first output via a first switch, and a second output coupled to a reference current circuit terminal via a second switch. The transconductance amplifier circuit is configured to provide a first output current at the first output based on a differential between a first voltage at the first input and a second voltage at the second input. The current limiting circuit is configured to provide a second output current at the second output that is an input current at the third input limited to no greater than the first output current. The controller is configured to control the first and second switches during a time period where the power conversion circuit transits from an active mode to a skip mode, while operating in the save mode.

### General Overview

DC-DC power converters are useful for powering many different types of devices, including devices that are capable of ultra-low power (e.g., idle or standby) operations. Such devices can transition between a normal mode during periods of activity, when power consumption is relatively high, and a power save mode during periods of quiescent operations, when power consumption is relatively low (e.g., microamperes of load current). Within the power save mode, the converter can operate in an active mode where the inductor current is not zero (active switching) and a skip mode where the inductor current is zero. As described above, there remain a number of non-trivial issues with respect to limiting the gain of the regulating integrator of the converters during the transition between active mode and skip mode and in the active mode of the power save mode. For example, depending on the design, there may be trade-offs between the precision with which the power converter regulates the output voltage and the load transient response of the power converter. For instance, one possible approach is to use a purely passive skip clamp. In such cases, the power converter may produce a significant voltage undershoot due to a large clamping offset voltage in the skip clamp and a long comparator propagation delay. To improve efficiency and provide a robust load transient response, examples described herein include power converter architectures configured to dynamically provide a relatively seamless or smooth transition between active mode and skip mode in the power save mode operation.

An example includes a DC-DC power converter. In a skip mode of operation, the DC-DC power converter is not operational (e.g., a power switching network that is not actively switching), a skip clamp circuit is used to limit the voltage swing of the output of the integrator. To reduce the compromise between regulation precision and load transient response, the DC-DC power converter may include a pre-gain stage that includes a transconductance amplifier configured to produce a cancellation current proportional to the clamping offset voltage. The cancellation current is actively limited by a sensed output current of an integrator during the transition to the skip mode, to avoid the power converter from exiting the skip mode prematurely, and is injected into a reference voltage output from the integrator to cancel part of the integrator output current, thereby producing a relatively small, well-controlled clamping offset voltage.

### Circuit Architecture and Signal Timing

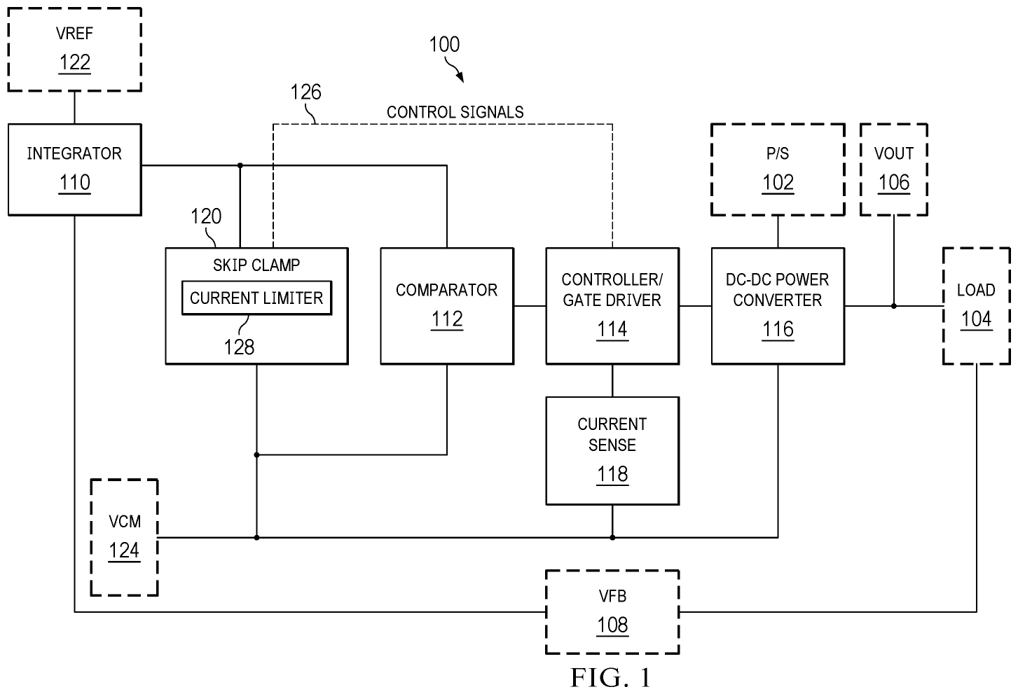

FIG. 1 is a block diagram of a power converter 100, in accordance with an example of the present disclosure. The power converter 100, or portions thereof, can be implemented as one or more integrated circuits. The power converter 100 is configured to regulate power supplied by a power source (P/S) 102 (V_{IN}) into an output voltage 106 (V_{OUT}) for a load 104. The power converter 100 includes an integrator 110, a comparator 112, a controller/gate driver 114, a DC-DC power converter 116, a current sense circuit 118, a skip clamp 120, and a current limiter 128. The DC-DC power converter 116 can include, for example, a switched inductor-capacitor (LC) circuit for regulating the output voltage 106. The DC-DC power converter 116 is controlled by the controller/gate driver 114, which can include, for example, a digital logic controller for switching the LC circuit of the DC-DC power converter 116. The controller/gate driver 114 can be implemented with any suitable power switching control scheme and associated circuitry, such as described in further detail below.

The power converter 100 is further configured to operate in a normal mode and a power save mode. In normal mode, the power converter 116 powers the load 104 under normal operating conditions of the load 104. In power save mode (as opposed to normal mode), the power converter 116 is switching with a reduced frequency compared to the normal mode, where the power save mode further includes an active mode operation and skip mode operation. In the active mode of the power save mode operation, the power converter is switching. The power converter 116 powers the load 104 while also charges the capacitor. In the skip mode of the power save mode operation, the residual charge in the capacitor provides power (or no power) to the load 104. Power save mode occurs when the load 104 is idle, in standby operations, or powered down. Power save mode can be used, for example, to increase the efficiency and/or decrease the power consumption of the power converter 100, such as when the power source 102 is a battery. For instance, in light load conditions, the power converter 100 enters a so-called sleep state where the circuitry uses a quiescent current and the load is supported by a charge stored in the capacitor of the DC-DC power converter 116. This can be achieved, for example, using a low power voltage reference and an integrated high impedance feedback divider network, such as described in further detail below.

In the power save mode, the power converter 100 is configured to switch from active mode to skip mode, and from skip mode to active mode, depending on the output voltage 106. The current sense circuit 118 is configured to sense a current flowing through the DC-DC power converter 116 (e.g., an inductor current). For example, when the current sense circuit 118 senses that the current flowing through the DC-DC power converter is low or zero, the current sense circuit 118 can signal the controller/gate driver 114 to enter skip mode. In some embodiments, the power converter 100 includes a common mode voltage generator (VCM) 124 to set up the common mode input voltage of the comparator 112 for the power converter 100.

The current limited output stage of the skip clamp 120, such as described in further detail below, reduces the voltage undershoot of the power converter 100 if and when a load surge event occurs during a transition period from active mode to skip mode, meanwhile preventing mis-tripping the comparator 112, which, under certain conditions, can cause the power converter 100 to exit skip mode prematurely. The skip clamp 120 is controlled in part via control signals 126 from the controller/gate driver 114 and in part by the integrator 110.

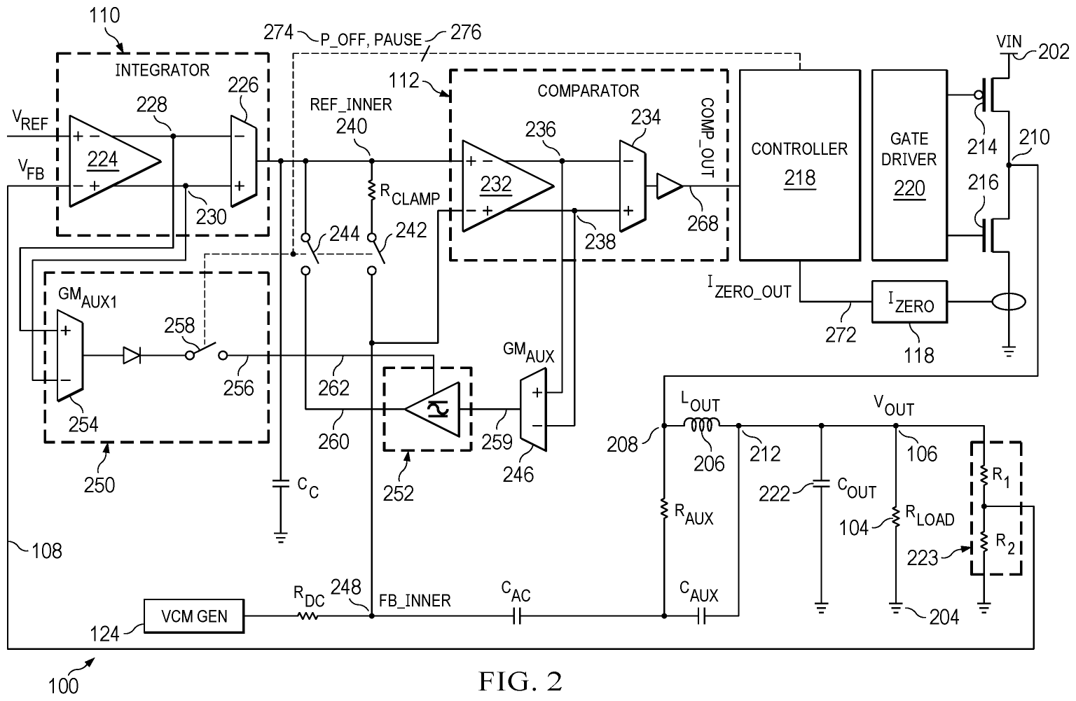

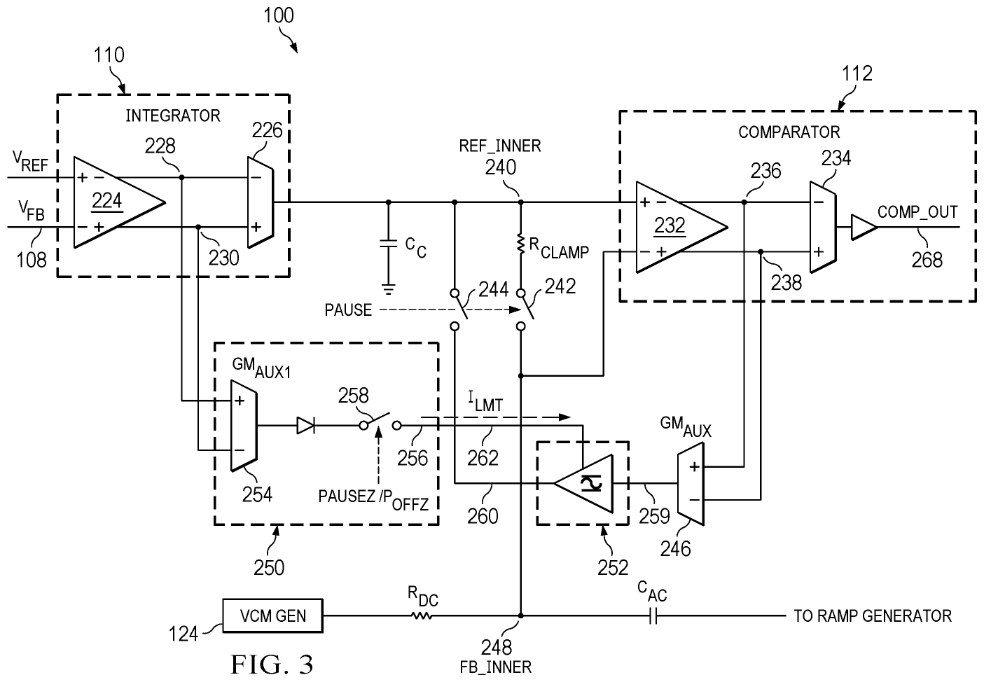

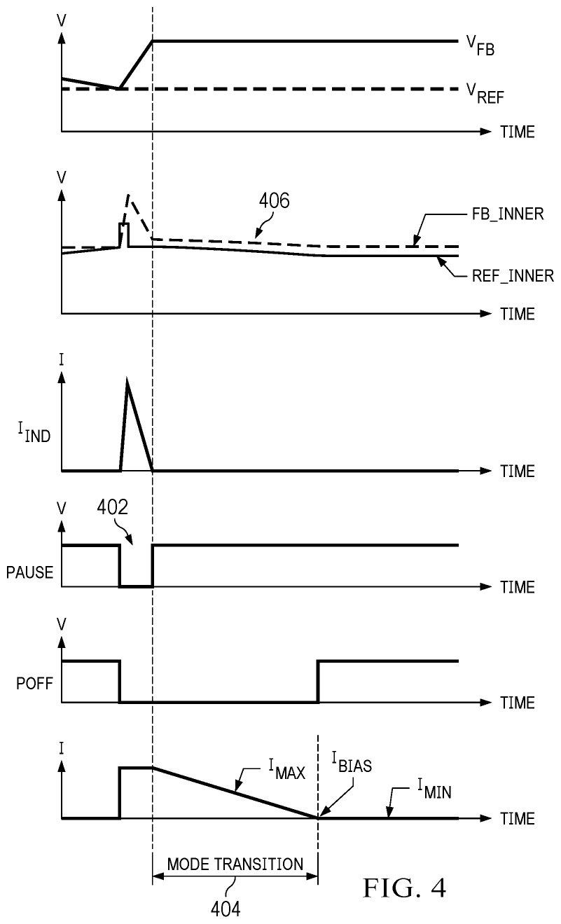

FIG. 2 is a circuit diagram of the power converter 100 of FIG. 1, and FIG. 3 is a circuit diagram of a portion of the circuit shown in FIG. 2 with additional details illustrated, in accordance with examples of the present disclosure. FIG. 4 illustrates signal timing of the power converter 100 of FIG. 1 during power save mode operation, in accordance with an example of the present disclosure.

Referring first to FIG. 2, the power source 102, such as shown in FIG. 1, provides an input voltage V_{IN} 202 to the power converter 100. The power converter 100 provides a regulated voltage to the load 104 via the output node V_{OUT} 106. For example, when the power converter 100 is operated in a buck mode, the regulated voltage at the output node V_{OUT} 106 is less than the input voltage V_{IN} 202 with respect to a ground 204. When the power converter 100 is operated in a boost mode, the regulated voltage at the output node V_{OUT} 106 is greater than the input voltage V_{IN} 202 with respect to the ground 204. When the power converter 100 is operated in a buck-boost mode, a magnitude of the regulated voltage at the output node V_{OUT} 106 can be greater or less than the input voltage V_{IN} 202. An inductor L_{OUT} 206 includes a first terminal 208 coupled to a switching node 210, and a second terminal 212 coupled to the load 104 via the output node V_{OUT} 106.

The mode of operation of the power converter 100 is controlled by transistors 214 and 216, which in turn are controlled by a controller 218 and a gate driver 220. For example, the controller 218 and gate driver 220 cause the transistors 214 and 216 to alternately switch on and off to charge the inductor L_{OUT} 206, which is discharged by the load 104. An output capacitor 222 is coupled to the load 104 to regulate the voltage at the output node V_{OUT} 106. A voltage divider 223, including resistors R₁ and R₂, is coupled to the output node V_{OUT} 106 and provides the feedback voltage 108 to the integrator 110.

Referring now to FIG. 3, the integrator 110 includes a pre-amplifier 224 and a transconductance amplifier 226. Outputs of the pre-amplifier 224 and inputs to the transconductance amplifier 226 are each coupled to a first integrator circuit terminal 228 and a second integrator circuit terminal 230. The comparator 112 includes a pre-amplifier amplifier 232 and a transconductance amplifier 234. Outputs of the pre-amplifier 232 and inputs to the transconductance amplifier 234 are each coupled to a first comparator circuit terminal 236 and a second comparator circuit terminal 238.

At the start of skip mode, a first switch 242 is closed. In some examples, a second switch 244 is closed simultaneously or nearly simultaneously, such as shown at 402 in FIG. 4, where the first switch 242 and the second switch 244 are each controlled by the PAUSE signal. When the power converter 100 is in skip mode—for example, when the current through the inductor 206 is detected at zero by the current sense circuit 118—the feedback voltage 108 is higher than the reference voltage V_{REF}—122. This causes the integrator 110 to sink current from an inner reference node REF_INNER 240. Current flows through the first switch 242 and resistor R_{CLAMP} creating a differential voltage at the input of the comparator 112. The pre-amplifier amplifier 232 will translate the differential voltage at the input of the comparator 112 through a transconductance amplifier 246, which sources a bias current passing through the second switch 244 that cancels a part of the integrator sinking current at the inner reference node 240. This reduces the current passing through the first switch 242 and resistor R_{CLAMP} to provide a small clamping voltage at the input of the comparator 112.

However, in some examples, when the first switch 242 is initially closed upon entering skip mode, the pre-amplifier 232 of the comparator 112 and the transconductance amplifier 246 output a very high current. This current, if not limited, is then sourced by the transconductance amplifier 246 to the inner reference node 240, which pulls up the current at the inner reference node 240 and can consequently cause a runaway condition at the input to the comparator 112 Such a runaway condition can cause a mis-tripping of the comparator 112, which can cause the power converter 100 to exit skip mode prematurely.

In some other examples, switch 244 is closed at a delayed time compared to the switch 242, where the output current of the pre-amplifier 232 of the comparator 112 and the transconductance amplifier 246 settles to the quiescent value. This avoids the mis-tripping of the comparator 112. However, if a load surge event happens during the period that switch 242 is closed and 244 is still open, a bad load transient response with a large voltage undershoot can occur.

To mitigate such mis-tripping of the comparator 112 while still keeping a good load transient response, the bias current that is sourced from the comparator 112 to the inner reference node 240 via the transconductance amplifier 246 and the second switch 244 is limited dynamically using a transconductance amplifier circuit 250, a current limiting circuit 252, and the controller 218. For example, the current limiter 128 includes the transconductance amplifier circuit 250 and the current limiting circuit 252. The transconductance amplifier circuit 250 includes a first input coupled to the first integrator circuit terminal 228, a second input coupled to a second integrator circuit terminal 230, a transconductance amplifier 254, and a first output 256. The transconductance amplifier 254 is configured to provide a first output current at the first output 256 based on a differential between a first voltage at the first input and a second voltage at the second input. Note that in some embodiments, the transconductance amplifier 254 has the same or similar properties as the transconductance amplifier 226 so as to mirror or otherwise replicate the sinking current from the integrator 110 (e.g., at the inner reference node 240) at an input to the current limiting circuit 252 (e.g., a fourth input 262, as described below).

The current limiting circuit 252 includes a third input 259 coupled to a current source terminal (e.g., an output of the transconductance amplifier 246), a fourth input coupled to the first output 256 via a third switch 258, and a second output 260 coupled to the inner reference node 240 (also referred to herein as the inner reference current circuit terminal) via the second switch 244. The current limiting circuit 252 is configured to provide a second output current at the second output 260 that is an input current at the third input 259 limited to no greater than the first output current (e.g., a reference current from the integrator 110).

The second and third switches 244, 258 are configured to control a flow of the second output current during a time period where the power conversion circuit 100 transitions between an active mode and a skip mode. The third switch 258 can remain closed for a set period that accounts for the estimated time needed to transition into skip mode (e.g., approximately 20-80 microseconds), such as shown at 404 in FIG. 4 as “Mode Transition” time. Closing the third switch 258 permits the reference current from the integrator 101 (the input current at the fourth input 262) to dynamically limit the second output current at the second output 260.

In particular, the sensitivity of the comparator 112 to a load transient is a function of the difference between the voltage at the inner reference node 240 and the voltage at the inner feedback node 248. For instance, a load transient that occurs shortly after the current sense circuit 118 senses that the current flowing through the DC-DC power converter is zero can cause a voltage droop (dV/dt) at the inner feedback node 248. However, the voltage droop caused by a load transient must be relatively large to trip (to reverse the polarity of) the comparator 112 if the difference between the voltage at the inner reference node 240 and the voltage at the inner feedback node 248 is also relatively large. Thus, by injecting the second output current from the current limiting circuit 252 at the inner reference node 240 to at least partially cancel the sinking current from the integrator 110, the difference between the voltage at the inner reference node 240 and the voltage at the inner feedback node 248 is kept relatively small during the mode transition time 404, such as indicated at 406 in FIG. 4, which reduces or prevents a runaway condition (voltage undershoot). It will be appreciated that other examples of the power converter 100 may be configured differently and still provide comparable functionality.

### Controller State Table

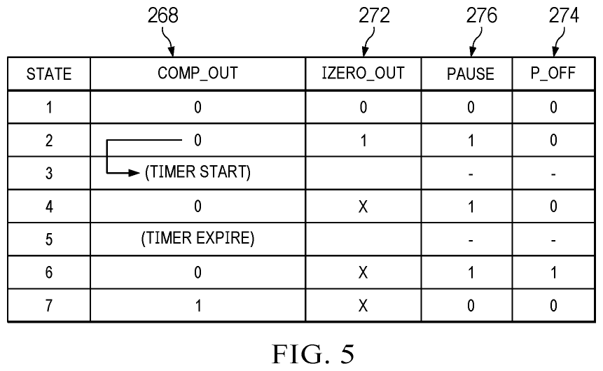

FIG. 5 is a state table of the controller 218, in accordance with an example of the present disclosure. The controller 218 receives as inputs a comparator output signal COMP_OUT 268 from the comparator 112 and a zero current signal IZERO_OUT 272 from the current sense circuit 118. The controller 218 generates as outputs the control signals 126 including a P_OFF control signal 274 and a PAUSE control signal 276 for controlling the switches 242, 244, and 258. (Note that P_OFFZ, such as shown in the drawings, represents the inverse state of P_OFF, e.g., if P_OFF=‘1’, then P_OFFZ=‘0’.) The current sense circuit 118 generates the zero current signal 272 when the current through the inductor 206 crosses zero (e.g., when the load 104 can be powered from energy stored in the capacitor 222 without recharging).

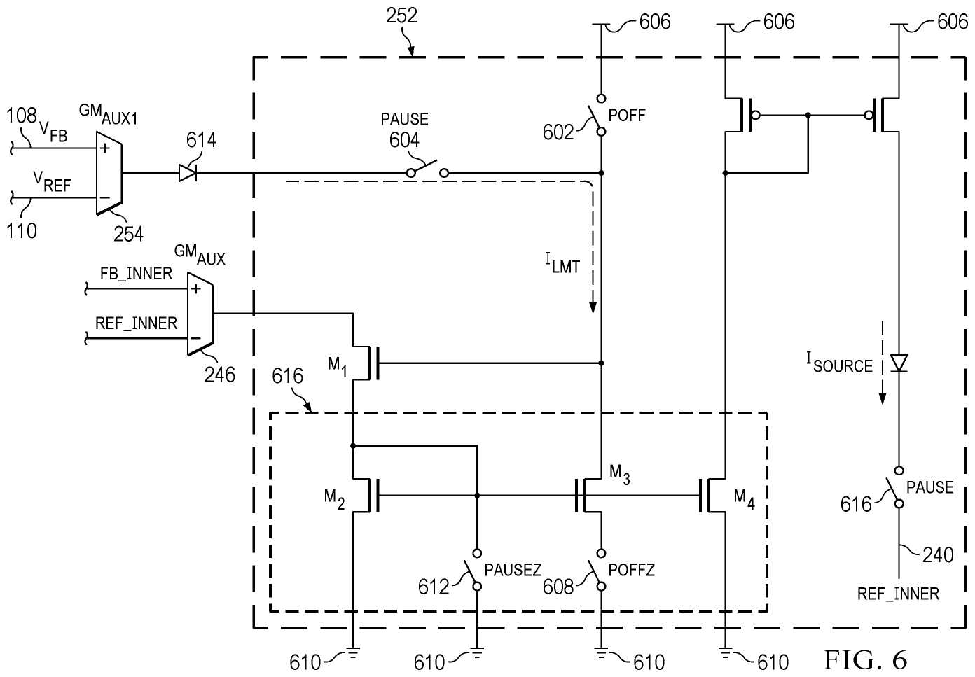

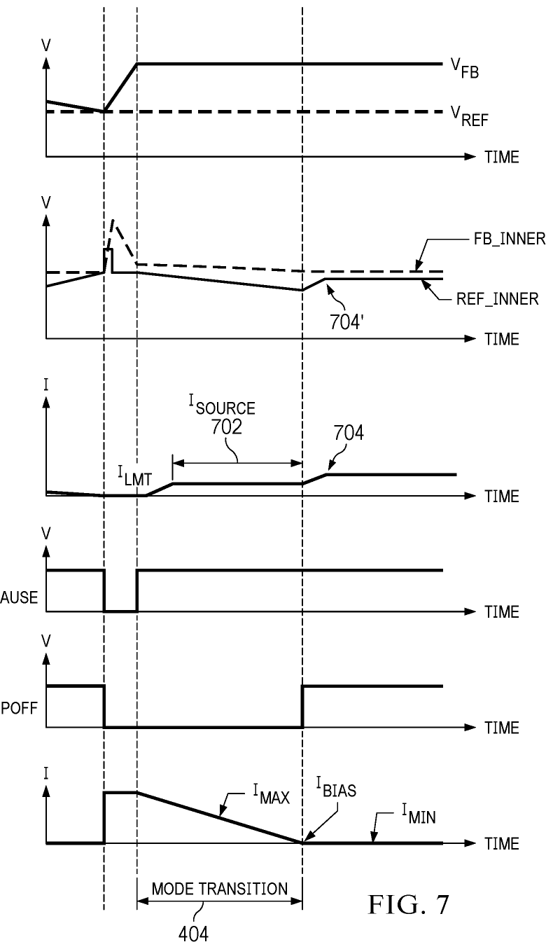

In STATE=1 the controller 218 sets the P_OFF control signal 274 to OFF and the PAUSE control signal 276 to OFF, such as shown in FIGS. 4 and 7. A rising edge of the zero current signal 272 (signal 272 is ‘1’ or ON) while the comparator output signal 268 is ‘0’ or OFF (STATE=2) indicates to the controller 218 that the power converter 100 is to enter skip mode. In STATE=2 the controller 218 sets the PAUSE control signal 276 to ‘1’ or ON. When the controller 218 is in STATE=3, the controller 218 starts a mode transition timer (STATE=3). In STATE=4, the PAUSE control signal 276 remains ON and the P_OFF control signal 274 remains OFF. An expiration of the timer at STATE=5 causes the controller 218 to set the P_OFF control signal 274 to ‘1’ or ON, such as shown in FIGS. 4 and 7 (STATE=6). A rising edge of the comparator output signal 268 (signal 268 is ‘1’ or ON) indicates to the controller 218 that the power converter 100 is to enter active mode (STATE=7). In STATE=7, the controller 218 sets the PAUSE control signal 276 to ‘0’ or OFF and the P_OFF control signal 274 to ‘0’ or OFF. The use of the P_OFF control signal 274 and the PAUSE control signal 276 are described in further detail with respect to FIG. 6.

### Current Limiting Circuit Architecture and Signal Timing

FIG. 6 is a schematic diagram of a portion of the power converter 100 representing the current limiting circuit 252, in accordance with an example of the present disclosure. FIG. 7 illustrates simulated results of power save mode operations of the power converter 100 of FIG. 1, in accordance with an example of the present disclosure. As discussed above, the current limiting circuit 252 is configured to provide an output current at the output 260, which is coupled to the inner reference node 240 where the output current of the current limiting circuit 252 is limited to the sink current I_{LMT} (a replica of the sinking current from the integrator 110). As shown in FIG. 6, a switch 602 coupled between a voltage rail 606 and the transistor M₃ is open during the transition to skip mode (while the P_OFF control signal is OFF) such that the current limiting circuit 252 is active only during the transition period.

In more detail, a switch 604 is coupled between the transconductance amplifier 254 and a drain terminal of a transistor M₃ and is closed when the PAUSE control signal is ON. A switch 616 coupled between a DC voltage rail 606 and the inner reference node 240 (e.g., switch 244) is also closed when the PAUSE control signal is ON. A switch 608 coupled between a source terminal of the transistor M₃ and a ground 610 is closed when the P_OFF control signal is OFF. A switch 612 coupled between a gate terminal of the transistor M₃ and the ground 610 is closed when the PAUSE control signal is OFF.

During the transition to skip mode, while the P_OFF control signal is OFF, the transconductance amplifier 254 generates a replica of the sink current I_{LMT} from the integrator 110 via a current extractor 614 when the feedback voltage V_{FB} is greater than the reference voltage V_{REF}. The transconductance amplifier 254 sources the replica sink current I_{LMT} to a current mirror 616 including transistors M₂, M₃ and M₄. The replica sink current I_{LMT} of the current limiting circuit 252 thus effectively limits the amount of current I_{SOURCE} sourced to the inner reference node 240 via the output 260 during the transition 404 to skip mode, as indicated at 702 in FIG. 7.

At the end of the transition to skip mode, when the P_OFF control signal is ON, the switch 608 is open disabling the current limiting function of the circuit 252 and the current sourced by the transconductance amplifier 246 is passed to the inner reference node 240, such as indicated at 704 and 704′ in FIG. 7. It will be appreciated that other examples of the power limiting circuit 252 may be configured differently and still provide comparable functionality.

### Transconductance Circuit Architecture

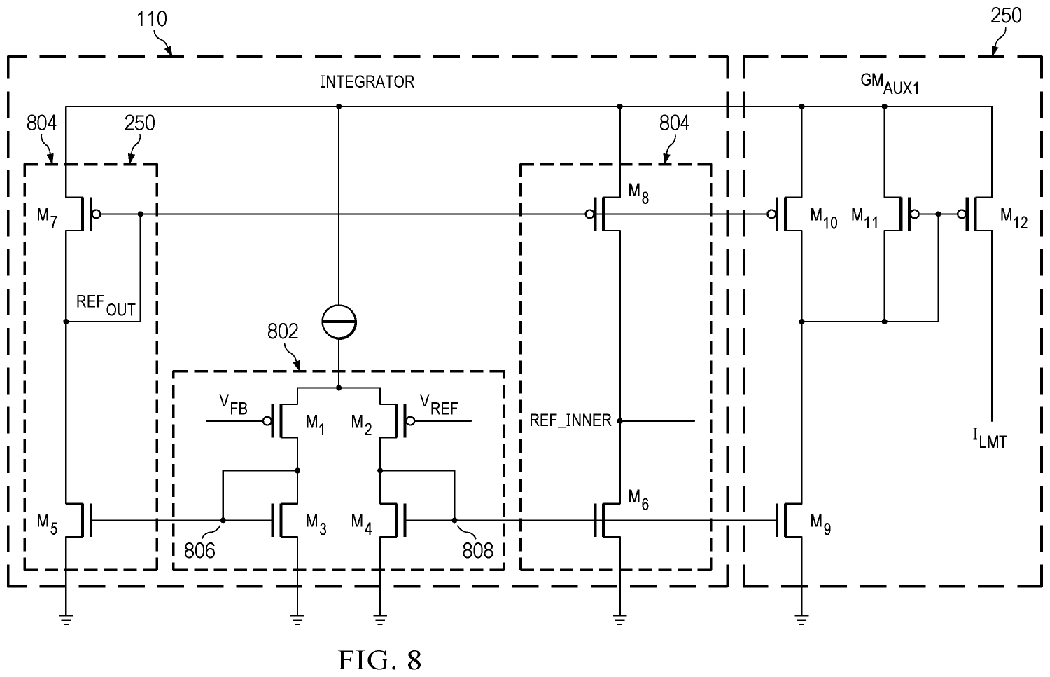

FIG. 8 is a schematic diagram of the integrator 110 and the transconductance amplifier circuit 250 of FIG. 2, in accordance with an example of the present disclosure. The transconductance amplifier circuit 250 includes a preamplifier 802 (e.g., the preamplifier 224) and a portion of a transconductance amplifier 804 (e.g., the transconductance amplifier 226). The preamplifier 802 includes transistors M₁, M₂, M₃, and M₄. The transconductance amplifier 804 includes transistors M₅, M₆, M₇, and M₈.

The preamplifier 802 converts a difference between the inputs V_{FB} and V_{REF} to transistors M₁ and M₂ into a voltage differential across the outputs of transistors M₃ and M₄, indicated at nodes 806 and 808, respectively. The transconductance amplifier 804 converts the voltage differential at nodes 806 and 808 into a current (e.g., a current at the inner reference node 240).

The transconductance amplifier circuit 250 includes M₅, M₇, M₉, M₁₀, M₁₁, and M₁₂. A first transistor (M₁₀) is coupled between a first voltage terminal and a second voltage terminal, and has a first control terminal coupled to the first input. A second transistor (M₉) is coupled between the first transistor and the second voltage terminal, and has a second control terminal coupled to the second input. A third transistor (M₁₁) is coupled in parallel with the first transistor, and has a third control terminal. A fourth transistor (M₁₂) is coupled between the first voltage terminal and the first output (I_{LMT}), and has a fourth control terminal coupled to the third control terminal. The transistors M₉ and M₁₀ provide transconductance scaling. For example, when V_{FB} is higher than V_{REF} then M₁₀ is sourcing less current than M₉ is sinking. The transistors M₁₁ and M₁₂ provide a current extractor and current mirror to extract the current output by the integrator 110 (I_{LMT}) at the first output, which is input to the current limiting circuit 252. It will be appreciated that other examples of the integrator 110 and the transconductance amplifier circuit 250 may be configured differently and still provide comparable functionality.

### Example Simulation

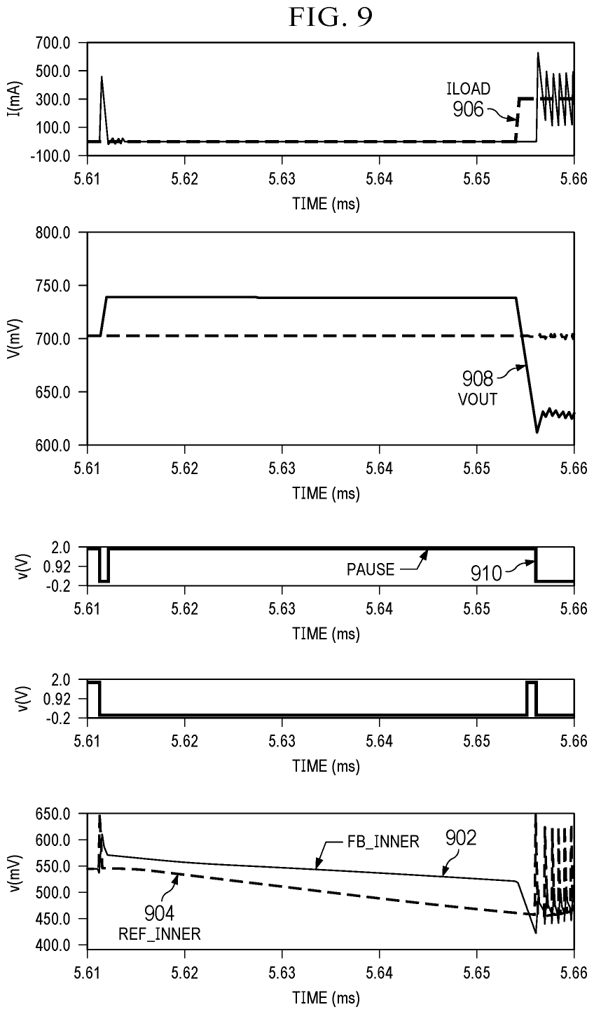

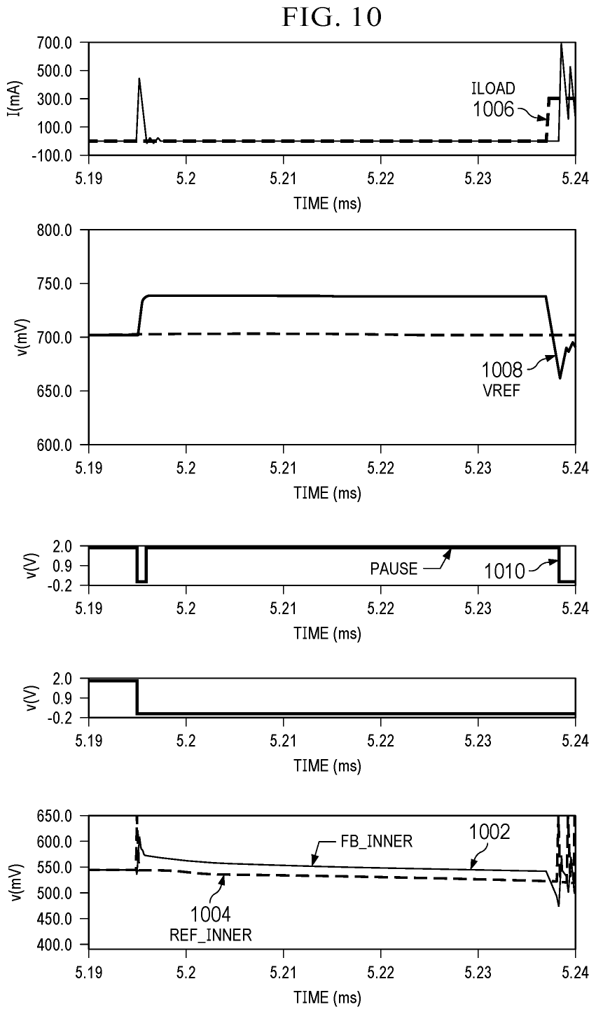

FIG. 9 is a graph depicting simulated performance of an example of a power converter with a skip clamp without a current limited output, and FIG. 10 is a graph depicting simulated performance of the power converter 100 of FIG. 1 over the same time scale as shown in the graph of FIG. 9. In both FIGS. 9 and 10, V_{IN} (202)=3.6V, V_{OUT} (106)=0.7V, L_{OUT} (inductor 206)=1 μH, and C_{OUT} (output capacitor 222)=4.7 μF. As can be seen in FIG. 9, an inner feedback voltage 902 increasingly diverges over time from an inner reference voltage 904. When a load transient occurs, as indicated at 906, there is a large output voltage undershoot, as indicated at 908, needed to change the output state of the comparator, as represented by a falling edge of the PAUSE signal at 910. By contrast, as can be seen in FIG. 10, an inner feedback voltage 1002 (e.g., at the inner feedback node 248) is well controlled and tracks closely with an inner reference voltage 1004 at the inner reference node 240. When the same load transient occurs, as indicated at 1006, there is a smaller output voltage undershoot, as indicated at 1008, needed to change the output state of the comparator, as represented by a falling edge of the PAUSE signal at 1010. In these examples, for a load transient of 300 mA, the voltage undershoot in the example of FIG. 9 is 90 mV and the voltage undershoot in the example of FIG. 10 is 45 mV.

### Further Examples

Example 1 is a power conversion circuit having a transconductance amplifier circuit, a current limiting circuit, and a controller. The transconductance amplifier circuit has a first input coupled to a first integrator circuit terminal, a second input coupled to a second integrator circuit terminal, and a first output. The transconductance amplifier circuit is configured to provide a first output current at the first output based on a differential between a first voltage at the first input and a second voltage at the second input. The current limiting circuit has a third input coupled to a current source terminal, a fourth input coupled to the first output via a first switch, and a second output coupled to a reference current circuit terminal via a second switch. The current limiting circuit is configured to provide a second output current at the second output that is an input current at the third input limited to no greater than the first output current. The controller is configured to control the first and second switches during a time period where the power conversion circuit transitions between an active mode and a skip mode.

Example 2 includes the subject matter of Example 1, wherein the transconductance amplifier circuit includes a first transistor coupled between a first voltage terminal and a second voltage terminal, and having a first control terminal coupled to the first input; a second transistor coupled between the first transistor and the second voltage terminal, and having a second control terminal coupled to the second input; a third transistor coupled in parallel with the first transistor, and having a third control terminal; and a fourth transistor coupled between the first voltage terminal and the first output, and having a fourth control terminal coupled to the third control terminal.

Example 3 includes the subject matter of any one of Examples 1 and 2, wherein the transconductance amplifier circuit is a first transconductance amplifier circuit, and wherein the power conversion circuit further includes a second transconductance amplifier circuit having a fifth input coupled to a first comparator circuit terminal, a sixth input coupled to a second comparator circuit terminal, and a third output coupled to the current source terminal, the second transconductance amplifier circuit configured to provide the input current at the third input based on a differential between a third voltage at the fifth input and a fourth voltage at the sixth input.

Example 4 includes the subject matter of Example 3, wherein the reference current circuit terminal is coupled to an output of an integrator circuit and an input of a comparator circuit, the integrator circuit configured to provide a third output current based on a reference voltage and a feedback voltage, the comparator circuit configured to provide an output voltage to a digitally controlled DC-DC converter circuit based at least in part on the second output current.

Example 5 includes the subject matter of Example 4, wherein the reference current circuit terminal is further coupled, via a clamping resistor, to a current feedback terminal configured to provide a feedback current from an output of the digitally controlled DC-DC converter circuit.

Example 6 includes the subject matter of any one of Examples 1-5, further including an integrator circuit coupled to the first integrator circuit terminal and the second integrator circuit terminal, the integrator circuit configured to provide a third output current based on a reference voltage and a feedback voltage.

Example 7 includes the subject matter of any one of Examples 1-6, further including a comparator circuit coupled to the reference current circuit terminal, the comparator circuit configured to provide an output voltage to a digitally controlled DC-DC converter circuit based at least in part on the second output current.

Example 8 includes the subject matter of Example 7, further including the DC-DC converter circuit, the DC-DC converter circuit configured to convert a first voltage level to a second voltage level different from the first voltage level.

Example 9 is an integrated circuit package including the subject matter of any one of Examples 1-8; a digitally controlled DC-DC converter circuit configured to convert a first voltage level to a second voltage level different from the first voltage level; an integrator circuit coupled to the first integrator circuit terminal and the second integrator circuit terminal, the integrator circuit configured to provide a third output current based on a reference voltage and a feedback voltage; and a comparator circuit configured to provide an output voltage to the digitally controlled DC-DC converter circuit based at least in part on the second output current.

Example 10 is a power conversion circuit having a transconductance amplifier circuit, a current limiting circuit, and a controller. The transconductance amplifier circuit is configured to provide a first output current based on a differential between a first voltage and a second voltage. The current limiting circuit is configured to provide a second output current that is an input current limited to no greater than the first output current. The controller is configured to control a switch coupled to an output of the current limiting circuit.

Example 11 includes the subject matter of Example 10, wherein the transconductance amplifier circuit is a first transconductance amplifier circuit, and wherein the power conversion circuit further includes a second transconductance amplifier circuit configured to provide the input current based on a differential between a third voltage and a fourth voltage.

Example 12 includes the subject matter of any one of Examples 10 and 11, further including a comparator circuit configured to provide an output voltage to a digitally controlled DC-DC converter circuit based at least in part on the second output current.

Example 13 includes the subject matter of any one of Examples 10-12, further including an integrator circuit coupled to the transconductance amplifier circuit and configured to provide a third output current based on a reference voltage and a feedback voltage.

Example 14 includes the subject matter of any one of Examples 10-13, wherein the controller is configured to control the switch during a time period where the power conversion circuit transitions between an active mode and a skip mode.

Example 15 is an integrated circuit package including the subject matter of any one of Examples 10-14.

Example 16 is a skip clamp circuit including a first transistor coupled between a first voltage terminal and a second voltage terminal, and having a first control terminal coupled to a first input; a second transistor coupled between the first transistor and the second voltage terminal, and having a second control terminal coupled to a second input; a third transistor coupled in parallel with the first transistor, and having a third control terminal; and a fourth transistor coupled between the first voltage terminal and an output, and having a fourth control terminal coupled to the third control terminal.

Example 17 includes the subject matter of Example 16, wherein the output is a first output, the skip claim circuit further including a current limiting circuit having a third input coupled to a current source terminal, a fourth input coupled to the first output via a first switch, and a second output coupled to a reference current circuit terminal via a second switch, the current limiting circuit configured to provide a second output current at the second output that is an input current at the third input limited to no greater than the first output current.

Example 18 includes the subject matter of any one of Examples 16 and 17, further including a transconductance amplifier circuit having a fifth input coupled to a first comparator circuit terminal, a sixth input coupled to a second comparator circuit terminal, and a third output coupled to the current source terminal, the transconductance amplifier circuit configured to provide the input current at the third input based on a differential between a third voltage at the fifth input and a fourth voltage at the sixth input.

Example 19 includes the subject matter of Example 18, wherein the reference current circuit terminal is coupled to an output of an integrator circuit and an input of a comparator circuit, the integrator circuit configured to provide a third output current based on a reference voltage and a feedback voltage, the comparator circuit configured to provide an output voltage to a digitally controlled DC-DC converter circuit based at least in part on the second output current.

Example 20 is an integrated circuit package including the subject matter of any one of Examples 16-19.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, such as by an end user and/or a third party.

While the use of particular transistors is described herein, other transistors (or equivalent devices) may be used instead. For example, a p-channel field effect transistor (PFET) may be used in place of an n-channel field effect transistor (NFET) with little or no changes to the circuit. Furthermore, other types of transistors may be used (such as bipolar junction transistors (BJTs)). Furthermore, the devices may be implemented in/over a silicon substrate (Si), a silicon carbide substrate (SiC), a gallium nitride substrate (GaN) or a gallium arsenide substrate (GaAs).

References herein to a field effect transistor (FET) being “ON” means that the conduction channel of the FET is present and drain current may flow through the FET. References herein to a FET being “OFF” means that the conduction channel is not present and drain current does not flow through the FET. A FET that is OFF, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter.

Modifications are possible in the described embodiments, and other embodiments are possible, within the scope of the claims.

What is claimed is:

1. A power conversion circuit, comprising:
a transconductance amplifier circuit having a first input coupled to a first integrator circuit terminal, a second input coupled to a second integrator circuit terminal, and a first output, the transconductance amplifier circuit configured to provide a first output current at the first output based on a differential between a first voltage at the first input and a second voltage at the second input;
a current limiting circuit having a third input coupled to a current source terminal, a fourth input coupled to the first output via a first switch, and a second output coupled to a reference current circuit terminal via a second switch, the current limiting circuit configured to provide a second output current at the second output that is an input current at the third input limited to no greater than the first output current; and
a controller configured to control the first and second switches during a time period where the power conversion circuit transitions between an active mode and a skip mode.

2. The power conversion circuit of claim 1, wherein the transconductance amplifier circuit comprises:
a first transistor coupled between a first voltage terminal and a second voltage terminal, and having a first control terminal coupled to the first input;
a second transistor coupled between the first transistor and the second voltage terminal, and having a second control terminal coupled to the second input;
a third transistor coupled in parallel with the first transistor, and having a third control terminal; and
a fourth transistor coupled between the first voltage terminal and the first output, and having a fourth control terminal coupled to the third control terminal.

3. The power conversion circuit of claim 1, wherein the transconductance amplifier circuit is a first transconductance amplifier circuit, and wherein the power conversion circuit further comprises:
a second transconductance amplifier circuit having a fifth input coupled to a first comparator circuit terminal, a sixth input coupled to a second comparator circuit terminal, and a third output coupled to the current source terminal, the second transconductance amplifier circuit configured to provide the input current at the third input based on a differential between a third voltage at the fifth input and a fourth voltage at the sixth input.

4. The power conversion circuit of claim 3, wherein the reference current circuit terminal is coupled to an output of an integrator circuit and an input of a comparator circuit, the integrator circuit configured to provide a third output current based on a reference voltage and a feedback voltage, the comparator circuit configured to provide an output voltage to a digitally controlled DC-DC converter circuit based at least in part on the second output current.

5. The power conversion circuit of claim 4, wherein the reference current circuit terminal is further coupled, via a clamping resistor, to a current feedback terminal configured to provide a feedback current from an output of the digitally controlled DC-DC converter circuit.

6. The power conversion circuit of claim 1, further comprising an integrator circuit coupled to the first integrator circuit terminal and the second integrator circuit terminal, the integrator circuit configured to provide a third output current based on a reference voltage and a feedback voltage.

7. The power conversion circuit of claim 1, further comprising a comparator circuit coupled to the reference current circuit terminal, the comparator circuit configured to provide an output voltage to a digitally controlled DC-DC converter circuit based at least in part on the second output current.

8. The power conversion circuit of claim 7, further comprising the digitally controlled DC-DC converter circuit, the digitally controlled DC-DC converter circuit configured to convert a first voltage level to a second voltage level different from the first voltage level.

9. An integrated circuit package comprising:
the power conversion circuit of claim 1;
a digitally controlled DC-DC converter circuit configured to convert a first voltage level to a second voltage level different from the first voltage level;
an integrator circuit coupled to the first integrator circuit terminal and the second integrator circuit terminal, the integrator circuit configured to provide a third output current based on a reference voltage and a feedback voltage; and
a comparator circuit configured to provide an output voltage to the digitally controlled DC-DC converter circuit based at least in part on the second output current.

10. A power conversion circuit comprising:
a transconductance amplifier circuit configured to provide a first output current based on a differential between a first voltage and a second voltage;
a current limiting circuit configured to provide a second output current that is an input current limited to no greater than the first output current; and
a controller configured to control a switch coupled to an output of the current limiting circuit.

11. The power conversion circuit of claim 10, wherein the transconductance amplifier circuit is a first transconductance amplifier circuit, and wherein the power conversion circuit further comprises a second transconductance amplifier circuit configured to provide the input current based on a differential between a third voltage and a fourth voltage.

12. The power conversion circuit of claim 10, further comprising a comparator circuit configured to provide an output voltage to a digitally controlled DC-DC converter circuit based at least in part on the second output current.

13. The power conversion circuit of claim 10, further comprising an integrator circuit coupled to the transconductance amplifier circuit and configured to provide a third output current based on a reference voltage and a feedback voltage.

14. The power conversion circuit of claim 10, wherein the controller is configured to control the switch during a time period where the power conversion circuit transitions between an active mode and a skip mode.

15. An integrated circuit package comprising the power conversion circuit of claim 10.

16. A skip clamp circuit comprising:
a first transistor coupled between a first voltage terminal and a second voltage terminal, and having a first control terminal coupled to a first input;
a second transistor coupled between the first transistor and the second voltage terminal, and having a second control terminal coupled to a second input;
a third transistor coupled in parallel with the first transistor, and having a third control terminal; and
a fourth transistor coupled between the first voltage terminal and an output, and having a fourth control terminal coupled to the third control terminal.

17. The skip clamp circuit of claim 16, wherein the output is a first output, the skip claim circuit further comprising:
a current limiting circuit having a third input coupled to a current source terminal, a fourth input coupled to the first output via a first switch, and a second output coupled to a reference current circuit terminal via a second switch, the current limiting circuit configured to provide a second output current at the second output that is an input current at the third input limited to no greater than the first output current.

18. The skip clamp circuit of claim 17, further comprising:
a transconductance amplifier circuit having a fifth input coupled to a first comparator circuit terminal, a sixth input coupled to a second comparator circuit terminal, and a third output coupled to the current source terminal, the transconductance amplifier circuit configured to provide the input current at the third input based on a differential between a third voltage at the fifth input and a fourth voltage at the sixth input.

19. The skip clamp circuit of claim 18, wherein the reference current circuit terminal is coupled to an output of an integrator circuit and an input of a comparator circuit, the integrator circuit configured to provide a third output current based on a reference voltage and a feedback voltage, the comparator circuit configured to provide an output voltage to a digitally controlled DC-DC converter circuit based at least in part on the second output current.

20. An integrated circuit package comprising the skip clamp circuit of claim 16.
